(19) United States
(12) Patent Application Publication
(10) Pub. No.: US 2025/0026227 A1
(43) Pub. Date: Jan. 23, 2025

(54) Systems and Methods for Optimizing Charging Schedules of Electric Vehicles with Varying Electricity Price and Charging Curves

(71) Applicant: ABB E-mobility B.V., Delft (NL)

(72) Inventors: Kaiyu Liu, Lakewood, CO (US); Alexander Brissette, Raleigh, NC (US); Zhenyuan Wang, Raleigh, NC (US); Parashar Parikh, Raleigh, NC (US)

(21) Appl. No.: 18/355,698

(22) Filed: Jul. 20, 2023

(51) Int. Cl. B60L 53/64; B60L 53/62; B60L 53/65

(52) U.S. Cl. CPC B60L 53/64; B60L 53/62; B60L 53/65; B60L 2240/54

(57) ABSTRACT

A method of managing charging of an EV at a charger is provided. The method includes receiving charging information of a charging session of an EV at a charger, wherein the charging information includes a desired SOC and a vehicle type of the EV. The method also includes obtaining charging curves of a battery of the EV based on the vehicle type, receiving an electricity pricing for the charger, and optimizing a charging schedule based on the charging curves and the electricity pricing. The charging schedule includes price periods and corresponding charging power during the price periods. Optimizing a charging schedule further includes prioritizing charging power for the price periods according to the electricity pricing of the price periods. Further, the method includes outputting the optimized charging schedule.

### BACKGROUND

The field of the disclosure relates generally to systems and methods of electric vehicles (EVs), and more particularly, to systems and methods of optimizing charging schedules of EVs.

EVs have become popular. With the growing popularity of EVs, known systems and methods are disadvantaged in some aspects in meeting the needs of EVs and improvements are desired.

### BRIEF DESCRIPTION

In one aspect, a charging management computing device for managing charging of an electric vehicle (EV) at a charger is provided. The charging management computing device includes at least one processor in communication with at least one memory device. The at least one processor is programmed to receive charging information of a charging session of an EV at a charger, wherein the charging information includes a desired state of charge (SOC) and a vehicle type of the EV. The at least one processor is further programmed to obtain charging curves of a battery of the EV based on the vehicle type, receive an electricity pricing for the charger, and optimize a charging schedule based on the charging curves and the electricity pricing, The charging schedule includes price periods and corresponding charging power of the price periods. The at least one processor is further programmed to optimize the charging schedule by initiating statuses of price periods, wherein the statuses reflect the charging power of the price periods. Optimizing the charging schedule also includes processing the price periods in an order of prices of the price periods by updating a status of the price period having the lowest price among unprocessed price periods as being charged at the maximum charging power, determining charged energy based on the charging curves and the updated statuses of the price periods, and repeating processing the price periods if a difference between the determined charged energy and an expected charged energy corresponding to the desired SOC is reduced. The at least one processor is further programmed to optimize the charging schedule by updating a status of the most recently updated price period. The at least one processor is further programmed to output the optimized charging schedule.

In another aspect, a method of managing charging of an EV at a charger is provided. The method includes receiving charging information of a charging session of an EV at a charger, wherein the charging information includes a desired SOC and a vehicle type of the EV. The method also includes obtaining charging curves of a battery of the EV based on the vehicle type, receiving an electricity pricing for the charger, and optimizing a charging schedule based on the charging curves and the electricity pricing. The charging schedule includes price periods and corresponding charging power during the price periods. Optimizing a charging schedule further includes prioritizing charging power for the price periods according to the electricity pricing of the price periods. Further, the method includes outputting the optimized charging schedule.

In one more aspect, a charging management computing device for managing charging of an EV at a charger is provided. The charging management computing device includes at least one processor in communication with at least one memory device. The at least one processor is programmed to receive charging information of a charging session of an EV at a charger, wherein the charging information includes a desired SOC. The at least one processor is also programmed to receive an electricity pricing for the charger, and optimize a charging schedule based on the electricity pricing. The charging schedule includes price periods and corresponding charging power during the price periods. The at least one processor is further programmed to optimize a charging schedule by dividing the charging session into price periods based on the electricity pricing, wherein neighboring price periods have different prices, initiating statuses for the price periods as being charged at a maximum charging power, and processing a price period having the highest price among unprocessed price periods. Processing a price period further includes determining charged energy based on the statuses of the price periods, and determining charged energy to be reduced based on the determined charged energy and an expected charged energy corresponding to the desired SOC. If the price period is not the last price period in the charging session, processing a price period further includes comparing the charged energy to be reduced with a difference between a first charged energy of the price period when being charged at the maximum power and a second charged energy of the price period when being charged at the minimum power. If the charged energy to be reduced is greater than the difference, processing a price period includes setting a charging power of the price period to be at the minimum charging power and going back to determining charged energy based on the statuses. If the price period is the last price period, processing a price period further includes comparing the charged energy to be reduced with a maximum charged energy of the price period when being charged at the maximum power. If the charged energy to be reduced is greater than the maximum charged energy of the price period, processing a price period further includes setting a charging power of the price period to zero, and going back to determining charged energy based on the statuses. The at least one processor is also programmed to output the optimized charging schedule.

### BRIEF DESCRIPTION OF DRAWINGS

These and other features, aspects, and advantages of the present disclosure will become better understood when the following detailed description is read with reference to the accompanying drawings in which like characters represent like parts throughout the drawings.

FIG. 1 is a schematic diagram of a charging control system for managing charging of electric vehicles (EVs).

FIG. 2A is an example method of optimizing charging schedule of EVs.

FIG. 2B is a flow chart of an example embodiment of the method shown in FIG. 2A.

FIG. 2C is a flow chart of an example method of optimizing the charging schedule with a number of price periods.

FIG. 2D is a diagram of price periods.

FIG. 3 is a flow chart of an example method of optimizing the charging schedule with a number of price periods.

FIG. 4A shows inputs and outputs of an example outcome for the method of generating charging curves of an EV.

FIG. 4B shows example charging curves generated using systems and methods described herein.

FIG. 5 shows charging curves updated with consideration of the maximum charging power of a charger.

FIG. 6 is a flow chart of another example method of optimizing charging schedule with a number of price periods.

FIGS. 7A-7E show example charged energy curves and charging power curves during optimization of the charging schedule using the method shown in FIG. 6.

FIG. 8A is a flow chart of an example method of finding a time value corresponding to an input charged energy value.

FIG. 8B is a flow chart of an example method of finding the charged energy corresponding to a time value.

FIG. 9 is a block diagram of an example computing device.

FIG. 10 is a block diagram of an example server computing device.

### DETAILED DESCRIPTION

The disclosure includes systems and methods for charging management of electric vehicles (EVs). An EV is a vehicle that operates on an electric motor, and may be a battery EV (BEV), a plug-in hybrid EV (PHEV), or a hybrid EV (HEV). Method aspects will be in part apparent and in part explicitly discussed in the following description.

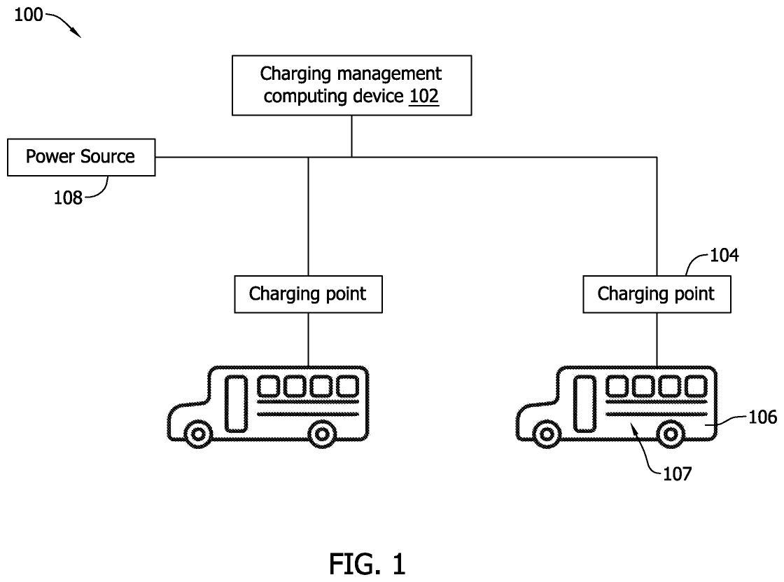

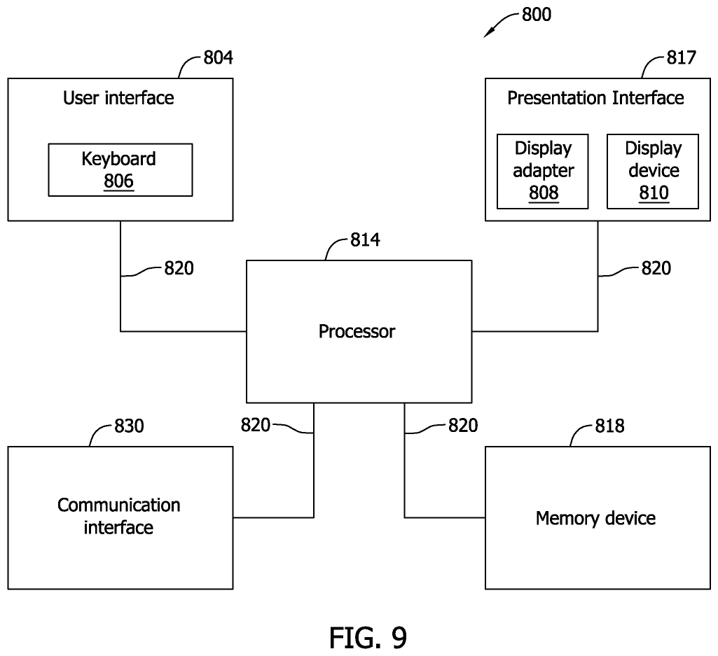

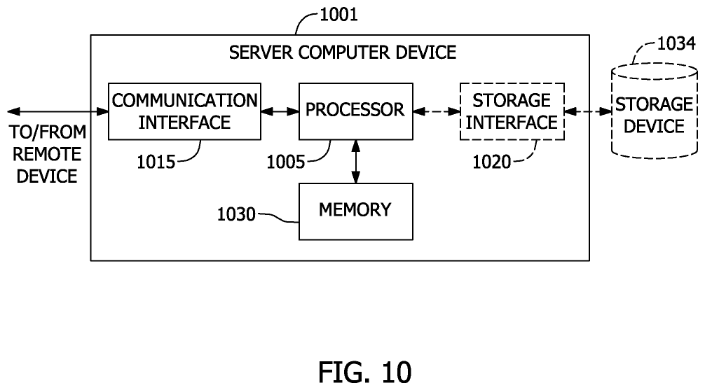

FIG. 1 is a schematic diagram of an example charging control system 100. In the example embodiment, charging control system 100 includes a charging management computing device 102. Charging management computing device 102 may be a computing device 800 (see FIG. 9 described later). Charging management computing device 102 may be a server computing device 1001 (see FIG. 10 described later). Charging control system 100 further includes charge point operators (CPOs) or chargers 104 in communication with charging management computing device 102 via wired or wireless communication. Charger 104 may be a point that an EV 106 is charged by receiving electric power from a power source 108 such as a power grid. Charger 104 may be a charging station, a charging outlet at home, office, or a facility such as a parking lot. EV 106 may be a personal vehicle such as a car or a truck, or a commercial vehicle such as a heavy truck, a bus, or a train. EV 106 may be a water vehicle such as a boat, or an aerial vehicle such as an airplane. A battery 107 of EV 106 may be recharged at charger 104. Battery 107 may be referred to as a traction battery, which is used to power the propulsion of EV 106. Charging management computing device 102 and/or charger 104 may communicate with EV 106 via wired or wireless communication.

With the fasting growing market of EVs, the demand on charging from EVs increases drastically. In response to the increase in demand, utility operators may adjust the pricing to disperse the demand to different time periods. For example, at peak hours, the price of electricity is more expensive than the price at off-peak hours. A charging schedule may be optimized to reduce the cost for a user.

In known methods, complicated optimization algorithms such as Newton optimization are used, where such complicated optimization algorithms require complex programming and relatively large memory and relatively fast computing power. As a result, a charger or a charger managing site may need to pay license fee and purchase a relatively expensive computing device in order to provide optimized charging schedules to users, increasing costs to chargers and causing inconvenience to users. Further, in known methods, the charging curves of the EVs are not considered. Instead, a constant charging power is assumed, which may askew the optimization.

In contrast, the systems and methods described herein provide optimized charging schedules without requiring a computing device having a relatively high computing power and a relatively large memory, thereby reducing the costs to chargers and/or charger managing sites, providing relatively fast solution in optimizing charging schedules, and improving user experience. A charger managing site is a facility that manages one or more chargers. The optimization methods described herein are relatively simple to implement such that a charger may implement the optimization in-house, further reducing costs to chargers and/or charger managing sites by eliminating licensing costs for chargers and/or charger managing sites. In addition, charging schedules may be optimized with consideration of charging curves of the battery, increasing the accuracy in optimization and the applicability of the methods and systems described herein to increased ranges and types of chargers.

Systems and methods described herein may be applied to both alternate current (AC) charging and direct current (DC) charging. A charging session starts from the start time and ends at the expected end time. A charging session is partitioned into price periods based on the pricing of electricity for the corresponding time periods. During a given price period, the price is constant. The last price period is the price period last in time in the charging session. The charging session may end before the expected charging end time and the end of charging is not the same as the expected charging end time such that the user may disconnect and leave the charger before the expected charging end time and the charger may provide service to the next customer sooner, thereby increasing the usage rate of the charger. A minimum charging power may be used for price periods that is not the last price period, to keep a charging session active. In some embodiments, all possible cases with different number of price periods are considered and the charging schedule having the minimum charging cost among the cases are selected as the optimal charging schedule. For AC charging, the charging power in the charging curves is constant at the maximum charging power of charger 104. For DC charging applications, a model of the battery charging curves as functions of charging time is generated based on the curve of charging power versus state of charge (SOC). An SOC indicates the level of charge in the battery and is represented as a percentage of the charge remained relative to the charge when the battery is fully charged, which is 100%. The charging curves include a curve of charged energy versus time and a curve of charging power versus time. The charging curves may be updated with the maximum charging power of the chargers because the maximum charging power of a battery is limited by the charging capacity of the battery and the maximum charging power of the charger in DC charging.

During optimization of a charging schedule, statuses may be used to indicate whether the charger is idle if the charging session ends before the expected charging end time or charges the battery at the maximum charging power or the minimum charging power for the price period. Statuses are assigned to price periods according to electricity pricing, where the price periods with lower prices have priority in being assigned to statuses of being charged at the maximum charging power over price periods with higher price. The assignment of statuses is performed under the condition that the desired SOC is met by the expected charging end time. Functions are used to find the corresponding time value to an charged energy value and corresponding charged energy to a time value based on the charging curves during the optimization. The charged energy of the price periods may be calculated according to the statuses and the charging curves using the functions.

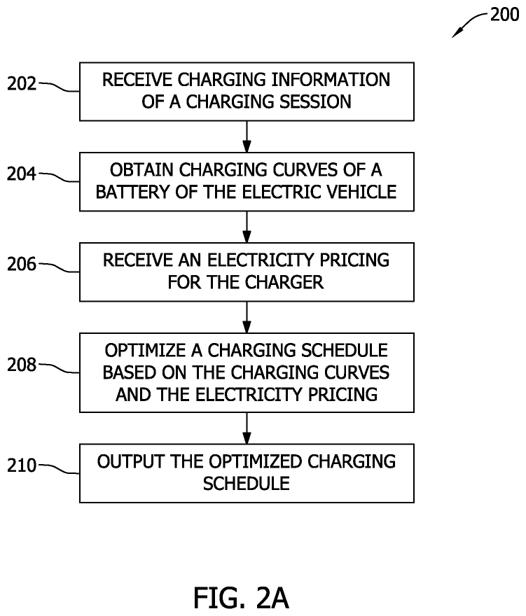

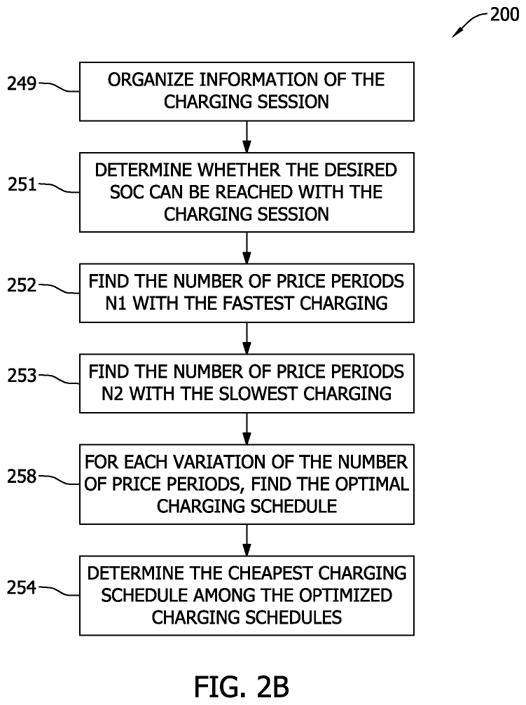

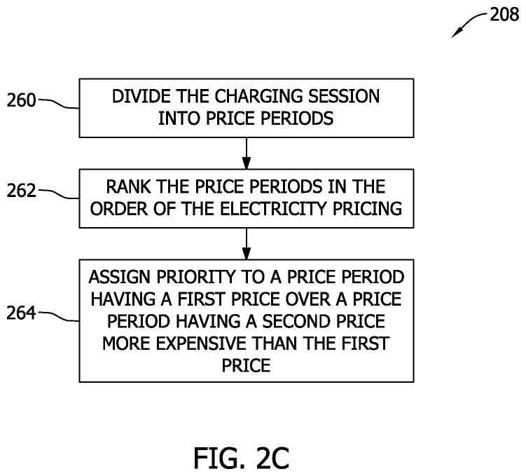

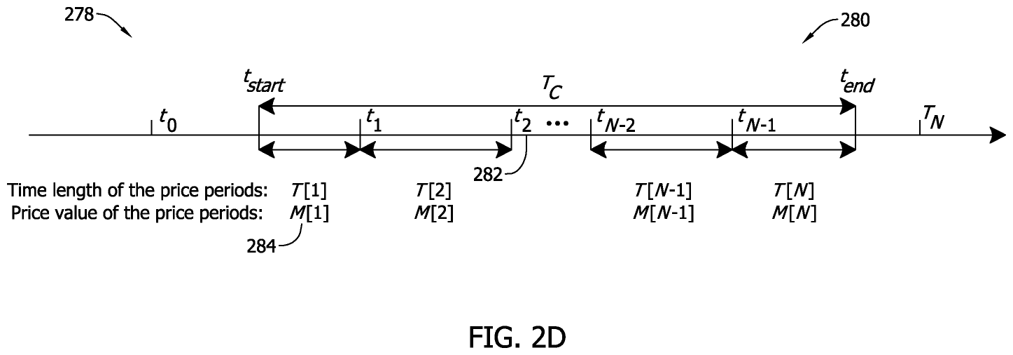

FIG. 2A is a flow chart of an example method 200 of managing charging of an EV. In the example embodiment, method 200 includes receiving 202 charging information of a charging session. Method 200 also includes obtaining 204 charging curves of a battery of the EV. Method 200 further includes receiving 206 an electricity pricing for the charger. Further, method 200 includes optimizing 208 a charging schedule based on the charging curves and the electricity pricing. In addition, method 200 includes outputting 210 the optimized charging schedule.

FIG. 2B is a flow chart of an example embodiment of method 200 in determining an optimal charging schedule with varying numbers of price periods. In the example embodiment, information of the charging session is organized 249. Whether the desired SOC can be reached with the charging session is determined 251. If the desired SOC cannot be reached, optimization is not conducted. Battery 107 will be charged at the maximum charging power during the entire charging session. If the desired SOC can be reached, optimization is conducted. The number of price periods N1 corresponding to the fastest charging is determined 252. N1 is the smallest number of price periods. In the fastest charging, battery 107 is charged at the maximum charging power for all price periods. As used herein, at the maximum charging power, the maximum available charging power is used to charge battery 107. For an AC charger, the maximum charging power of AC charger 104 is typically smaller than the maximum charging capacity or charging power of battery 107. The maximum charging power of battery 107 is the maximum charging power at which battery 107 may be charged. The maximum charging power in AC charging is typically the maximum charging power of AC charger 104. For a DC charger, the maximum charging power of DC charger 104 may be greater than, smaller than, or equal to the maximum charging power of battery 107 at a given time. The maximum charging power at a given time in a charging session is therefore limited by the maximum charging power of charger 104 and the maximum charging power of battery 107 at that give time. The maxim charging power in DC charging at a given time point is the smaller of the maximum charging power of charger 104 and the maximum charging power of battery 107 at the give time point.

In the example embodiment, the number of price periods N2 corresponding to the slowest charging is determined 253, where battery 107 is charged at the minimum charging power for all price periods. At the minimum charging power, battery 107 is being charged with the minimum charging power to keep the charging session active, such as 3 kw. For price periods i ranging from N1 to N2, the charging schedule is optimized 208. The optimization process 208 is repeated for all numbers of price periods ranging between N1 and N2. The final optimal charging schedule is chosen 254 as the charging schedule having the lowest price among the (N2−N1+1) number of optimized charging schedules.

FIGS. 2C and 2D show optimizing 208 a charging schedule based on the electricity pricing FIG. 2C is a flow chart of an example method of optimizing 208 based on the electricity pricing. FIG. 2D shows an example charging session. In the example embodiment, after information is obtained, a charging schedule is optimized 208. The charging session is divided 260 into price periods. The price periods are ranked 262 in the order of the electricity pricing. Priority of being charging at the maximum charging power is assigned 264 to a price period having a first price over a price period having a second price period more expensive than the first price.

In the example embodiment, when charger 104 is an AC charger, the maximum charging power of battery 107 is typically greater than the maximum charging power of charger 104. Therefore, the maxing charging power is typically limited by the charging power of AC charger 104. Charging may be in one of three statuses of i) being at a maximum charging power Pₘₐₓ, ii) being at a minimum charging power Pₘᵢₙ, and iii) being idle. When charging is at maximum charging power Pₘₐₓ, battery 107 is charged at maximum charging power Pₘₐₓ. Pₘₐₓ is determined by the maximum charging power of AC charger 104. When charging is at minimum charging power Pₘᵢₙ, battery 107 is charged at minimum charging power Pₘᵢₙ. A charging session ends when the charging power is zero and the charging status charges from being active to being idle, where the charging power is zero. Once charging becomes idle, a user would need to re-plug the charging adapter into charger 104 to start charging again. A minimum charging power Pₘᵢₙ is used to prevent a charging session from being ended before the charging session meets the SOC requested by the user. The minimum charging power required to keep a charging session active from the EV side or from the charger side is determined according to the standard for digital communication between an EV and a charger, such as ISO 15118. An example minimum charging power Pₘᵢₙ may be 3 kilowatt (kw).

In the example embodiment, charging information related to a charging session for an EV 106 may include the initial SOC Sᵢₙᵢ, the desired final SOC S_{final}, the start time of the charging session Tₛₜₐᵣₜ, charging time of the charging session T_{c}, battery capacity E_{bat}, maximum charging power Pₘₐₓ, and minimum charging power Pₘᵢₙ. Vehicle types may also be included in the charging information. Charging time Tc may be derived based on the desired end time of the charging session. The initial SOC, the desired final SOC, the start time of the charging session, the charging time, and the battery capacity may be obtained from EV 106 via communication between EV 106 and charger 104, or may be provided by a user in the request of a charging session. For example, the charging information may be entered through a mobile app, an interface of an web application, or a user interface on charger 104. Maximum charging power Pₘₐₓ and minimum charging power Pₘᵢₙ may be provided by charger 104. Optimizing 208 may include determining whether the desired SOC can be reached within the expected charging end time provided by the user. The maximum charged energy Et may be calculated as:

$${E}_{t} = {P}_{max} * {T}_{c} , \qquad ( 1 )$$

where Pₘₐₓ is the maximum charging power and Tc is the duration of the charging session. The expected charged energy ED to reach the desired final SOC is Eₚ=(S_{final}−Sᵢₙᵢ)*E_{bat}, where Sᵢₙᵢ is the initial SOC of the battery, S_{final} is the desired final SOC of the battery, and E_{bat} is the energy capacity of the battery. If Eₜ≥Eₚ, the desired SOC can be reached with the charging session and the desired charging power amount is E_{desired}=Eₚ. If Eₜ<Eₚ, the desired charging SOC cannot be reached with the charging session, and the charger will charge at the maximum charging power throughout the charging session.

In the example embodiment, if the desired SOC can be reached with the charging session, the charging schedule is optimized 208 based on the electricity pricing charged by a utility operator of charger 104. For example, a utility operator may charge $0.2 per kilowatt hour (kWh) from noon-2:00 PM, $0.3 per kWh from 2:00 PM to 4:00 PM, and $0.1 per kWh from 4:00 PM to 6:00 PM. A charging session 280 starting from Tₛₜₐᵣₜ, ending at T_{end}, and having a duration T_{c} may be divided into price periods 282 based on pricing 284. FIG. 2D is an example timeline diagram 278 showing charging session 280 is divided into price periods 282 based on pricing 284. Each price period 282 has the same price. Continuing with the above example, if EV 106 starts charging at 1:30 PM and the charging time is 4 hours, price periods 282 may include period 1 from 1:30 PM to 2:00 PM with a time length T[1] of 0.5 hour (h), period 2 from 2:00 PM to 4:00 PM with a time length T[2] of 2 h, and period 3 from 4:00 PM to 5:30 PM with a time length T[3] of 1.5 h. An array M[ ] may be used to indicate the corresponding price of price periods 282. The price periods are then ranked by corresponding prices, for example, from the most expensive to the least expensive.

In the example embodiment, the charging session is optimized 208 by assigning priority in charging at the maximum charging power to a price period having a first price over a price period having a second price more expensive than the first price, where a price period having a lower price has a priority over a price period having a higher price period in being assigned with maximum charging power Pₘₐₓ.

In the example embodiment, for a charging session 280 having i price periods, charged energy Es of a price period when all price periods are charged at the maximum charging power Pₘₐₓ is calculated as:

$$Es [ n ] = {P}_{max} * T [ n ] , n = 1 , 2 , … , i . \qquad ( 2 )$$

The amount of charged energy that needs to be cut to achieve expected charged energy E_{expected} is calculated as:

$${E}_{t} = {\sum }_{n = 0}^{i} Es [ n ] , and \qquad ( 3 )$$

$${E}_{D} = {E}_{t} - {E}_{expected} ,$$

where Eₜ is the charged energy from charging session 280 when all price periods are charged at the maximum charging power Pₘₐₓ and E_{D} is the charged energy that may be reduced by setting one or more price periods at the minimum charging power Pₘᵢₙ or zero as being idle.

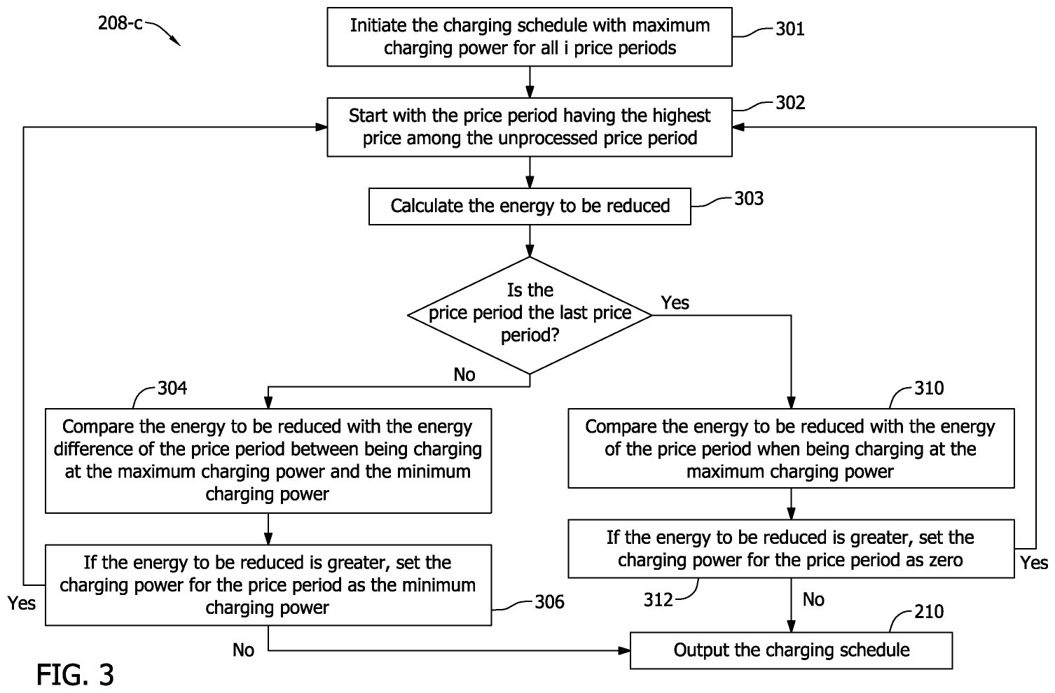

FIG. 3 is a flow chart of an example embodiment of optimizing 208-c a charging schedule. In the example embodiment, the maximum charging power to battery 107 is constant. In AC charging, the maximum charging power is typically constant. Charging session 280 includes a total of i's price periods. Method 208-c includes initiating 301 the charging schedule with maximum charging power for all i price periods. At the onset, the charged energy corresponding to a price period is the charged energy for that price period being charged at the maximum charging power Pₘₐₓ. The price periods are processed based on the prices of the price periods. Method 200 includes processing 302 a price period having the highest price among unprocessed price periods. Charged energy based on the statuses of the price periods is determined. Charged energy E_{D} to be reduced is determined 303 based on the determined charged energy and an expected charged energy corresponding to the desired SOC. If the price period is not last period, whether the charged energy E_{D} to be reduced is greater than the difference of the charged energy of the price period at the maximum charging power Pₘₐₓ over the charged energy of the price period at the minimum charging power Pₘᵢₙ is determined 304. If the charged energy E_{D} to be reduced is greater than the difference, the price period is set 306 as being charged at the minimum charging power. The charged energy E_{D} to be reduced is updated by subtracting the difference from the charged energy E_{D} to be reduced. The charged energy for the price period are updated to the charged energy of the price period when being charged at the minimum charging power. The price period is marked as having been processed. The process goes back to processing 302 a price period having the highest price among the unprocessed price periods. If the charged energy E_{D} to be reduced is equal to or less than the difference, the charging schedule for a charging session having i price periods is optimized.

In the example embodiment, if the price period is the last price period, whether the charged energy E_{D} to be reduced is greater than the charged energy of the price period at the maximum charging power Pₘₐₓ is determined 310. If the answer is yes, the price period is set 312 as being idle. The charged energy E_{D} to be reduced is updated by subtracting the charged energy of the price period at the maximum charging power Pₘₐₓ from the charged energy E_{D} to be reduced. The charged energy for the price period are updated to be zero. The price period is marked as having been processed. The process goes back to processing 302 a price period having the highest price among the unprocessed price periods. If the charged energy E_{D} to be reduced is equal to or less than the charged energy of the price period at the maximum charging power Pₘₐₓ, the charging schedule is optimized.

In the example embodiment, the charging power of the last processed price period may be determined as the final charged energy to be reduced being divided by the duration of the price period. Alternatively, if the price period is not the last price period, battery 107 is charged at the maximum charging power and then charged at the minimum charging power. The transition point from the maximum charging power to the minimum charging power may be iteratively determined. For example, the price period may be divided into intervals. The price period for all intervals are set at minimum charging power, and intervals in the price period are changed to maximum charging power one by one starting from the first interval of the price period until the charged energy of the price period reaches the expected charged energy for the price period. In some embodiments, the transition point may be determined by first setting the price period at maximum charging power and changing intervals to minimum charging power one by one starting from the last interval. If the price period is the last price period, battery is charged at maximum charging power. The charging session may end before the desired charging end time. The transition point from the maximum charging to being idle may be determined by dividing the final charged energy to be reduced by the maximum charging power.

In the example embodiment, after a charging schedule is optimized, the total charging price Ct of the entire charging session 280 is calculated as:

$${C}_{t} = {\sum }_{i = 0}^{N} Es [ i ] * M [ i ] . \qquad ( 4 )$$

The initial status may be set status other than being charging at the maximum. In changing the status of a price period, price period having a lower price takes priority in being charged at the maximum charging power over a price period having a higher price. For example, if the initial status is set as being charged at the minimum charging power, the status of the price period having the lowest price is updated first to be charged at the maximum charging power. If the difference between the charged energy of the price periods with the updated statuses and the expected charged energy for the charging session is reduced with the update, the updating continues with the next lowest price period among the unprocessed price periods. The goal of the updating process is to minimize the differences between the charged energy with the updated statuses and the expected charged energy.

Chargers are categorized into levels. Level 1 and 2 are AC chargers and have the maximum charging power ranging from 3 kw to 22 kw. Level 3 and up chargers are DC chargers and have the maximum charging power of 20 kw or higher. For an AC charger 104, the maximum charging power of AC charger 104 is smaller than the charging power of battery 107 and therefore the charging power of AC charger 104 is constant at the maximum charging power of AC charger 104. The charging power in DC charging, however, is not constant because the maximum charging power of DC charger 104 may be smaller than, equal to, or greater than the charging power of battery 107. The charging power of battery 107 is affected by the SOC. The maximum charging power of battery increases with the SOC when the SOC is relatively low and then starts to decrease after the peak charging power is reached. For example, when the SOC reaches 80%, the charging power may be much smaller than the peak charging power. Different types of EV have different charging curves. The design of changing charging power of battery 107 with the SOC is to provide longevity of battery 107. Accordingly, charging curves of an EV 106 are needed in optimizing charging schedule of the EV 106 in DC charging.

In the example embodiment, in deriving charging curves, the charged energy of battery 107 is denoted as E(t) and the charging power to battery 107 is denoted as P(t). The time period for the charging curves is divided into segments. When the charging power at the beginning of a segment is the same as the charging power at the end of the segment, the charging power may be assumed constant during the segment, and the differential equations of E(t) and P(t) are:

$$\frac{dE ( t )}{dt} = P ( t ) , \qquad ( 5 )$$

$$P ( t ) = b . \qquad ( 6 )$$

The solutions to the differential equations of E(t) (Eqn. (5)) and P(t) (Eqn. (5) are:

$$E ( t ) = b t + C , \qquad ( 7 )$$

$$P ( t ) = b . \qquad ( 8 )$$

When the charging power at the beginning of a segment is different from the charging power at the end of the segment, the charging power may be assumed having a linear relationship with the SOC of battery 107 in the segment, and the differential equations of E(t) and P(t) are:

$$\frac{dE ( t )}{dt} = P ( t ) , \qquad ( 9 )$$

$$P ( t ) = a E ( t ) + b . \qquad ( 10 )$$

Solutions to the differential equations of E(t) (Eqn. (9)) and P(t) (Eqn. (10)) are:

$$E ( t ) = \frac{{e}^{at + C} - b}{a} , \qquad ( 11 )$$

$$P ( t ) = {e}^{at + C} . \qquad ( 12 )$$

The solutions of Eqns. (7), (8), (11), and (12) may be used to generate charging curves of a battery 107.

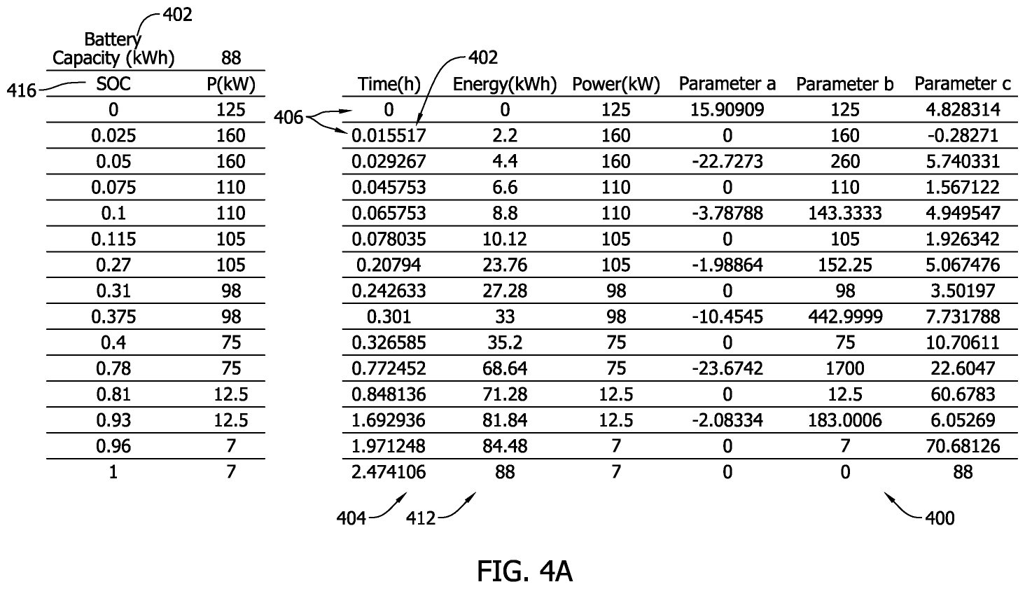

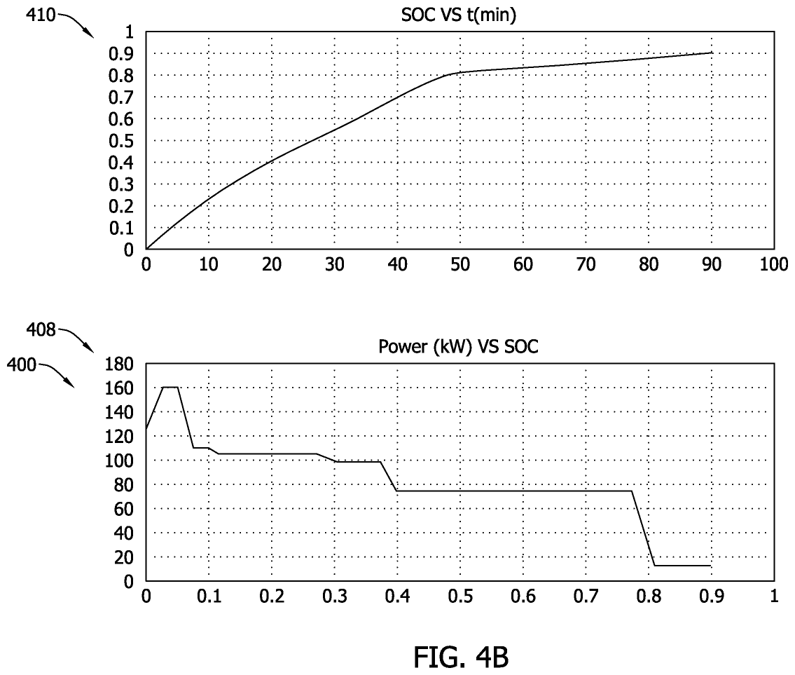

FIGS. 4A and 4B show example charging parameters and charging curves. FIG. 4A shows example input and output in generating charging curves. FIG. 4B shows example charging curves 400. In the example embodiment, in generating charging curves, input may include the battery capacity 402 of battery 107 and data points 404 of SOC values and corresponding charging power (FIG. 4A). Output may include time points, charged energy at the time points, charging power at the time points, and corresponding parameters a, b, and c in Eqns. (7), (8), (11) and (12) during each segment 406. For example, for a segment 406 from time 0 to time at 0.016 h, at the starting point of time 0, energy is at 0, power is at 125 kw, parameter a is 15.9, parameter b is 125, and parameter c is 4.8, at the end point of time 0.016 h of the segment, energy is 2.2 kWh, power is 160 kw, parameter a is 0, parameter b is 160, and parameter c is −0.28. The charging curves may include a charging power curve 408, a curve of charging power P (t) as a function of time. FIG. 4B shows an example charging power curve 408 generated based on the SOC curve 410, using Eqns. (7), (8), (10), and (12). Charging curves 400 may be stored as arrays 412 of parameters a, b, and c for a plurality of segments 406 (FIG. 4A) or as curves of charging power or charged energy as a function of time (FIG. 4B).

Charging curves 400 may be stored in a database. Charging curves 400 may be stored in charging managing computing device 102. Charging curves may be stored at a computing device, a user computing device and/or a server computing device, separate from charging managing computing device 102 and may be retrieved by charging managing computing device 102. Charging curves may be stored in portable storage devices such as flash drives.

Charging curves may include a charged energy curve, a curve of charged energy E (t) of the battery as a function of time. When the maximum capacity of DC charger 104 is not considered, the charged energy curve 414 is determined by the SOC curve 410, with charged energy E (t) being equal to battery capacity 402 multiplied by SOC 416 (see FIG. 4B). Energy curve 414 has the same curve as SOC curve 410, except that the units are different, with energy curve 414 being in a unit of energy such as kWh while SOC curve 410 being in a unit of percentage.

When the maximum capacity of DC charger 104 is considered, the charged energy curve 414 is updated because the charging power from a DC charger to battery 107 is also affected by the charging power of charger 104. As charging power 418 of battery 107 changes with the SOC, the charging power of charger 104 may be greater than, equal to, or smaller than the charging power of battery 107 at different SOC. The maximum charging power of charger 104 limits the charging power to the maximum charging power of charger 104 when the charging power of charger 104 is smaller than the charging power of battery 107.

In the example embodiment, charging curves are updated based on the maximum charging power of charger 104. For each segments in charging curves 400, the update is based on the check of each segment for intersection between the charging power curve with the maximum charging power of charger 104. There are four possible situations for each segment. The first situation is that both the charging power at the starting point and the charging power at the end point of the segment are smaller than the maximum charging power of the charger, where P[i]<Pmax and P[i+1]<Pmax. In this situation, EV 106 will be charged at the charging power of battery 107. The time values and parameter C in arrays 412 (see FIG. 4A) are updated according to Eqns. (7) and (8) or Eqns. (11) and (12), depending on whether parameter a is zero, where a zero parameter a indicates the charging power in the segment remains constant and a non-zero parameter a indicates the charging power changes in a linear manner in the segment.

In the example embodiment, in the second situation, both the charging power at the starting point and the charging power at the end point are greater than the maximum charging power of charger 104, where P[i]>Pmax and P[i+1]>Pmax. In this situation, battery 107 will be charged with the maximum charging power of charger 104 for the segment. The time values and parameters a, b, and c are updated according to Eqns. (7) and (8).

In the example embodiment, in the third situation, the charging power at the starting point of the segment is smaller than the maximum charging power of charger 104 while the charging power at the end point is greater than the maximum charging power of charger 104, where P[i]<Pmax and P[i+1]>Pmax. The fourth situation is opposite to the third situation. In the fourth situation, the charging power at the starting point is greater than the maximum charging power of charger 104 while the charging power at the end point is smaller than the maximum charging power of charger 104, where P[i]>Pmax and P[i+1]<Pmax. In both situations, the charging power curve of the segment intersect with the maximum charging power of charger 104. The intersection point is determined. The intersection point may be determined based on Eqn. (7), (8), (11) and (12), where charging curves with constant charging power and charging curves with linear changes in charging power intersect at the intersection point. At the intersection point, the charging curves yield the same charging power value. The segment is divided into two subsegments with the intersection point as the dividing point, where both charging powers at the starting point and the end point of the subsegment is either greater or smaller than the maximum charging power of charger 104. The subsegments may be treated like situation 1 or 2. For example, like in situation 1, in a subsegment where charging powers at the starting point and the end point are smaller than the maximum charging power of charger 104, battery is charged with the charging power capacity of battery. Time intervals and parameter c are updated according to Eqns. (7) and (8) or Eqns. (11) and (12). Like in situation 2, in a subsegment where charging powers at the starting point and the end point are greater than the maximum charging power of charger 104, the battery is charged with the maximum charging power of charger 104. The time values and parameters a, b, and c are updated according to Eqns. (7) and (8).

In the example embodiment, charging curves may be updated to consider the maximum charging power of the charger beforehand and the final charging curves may be read in during the optimization process. Alternatively, the charging curves may be updated during the optimization process after the initial charging curves are obtained.

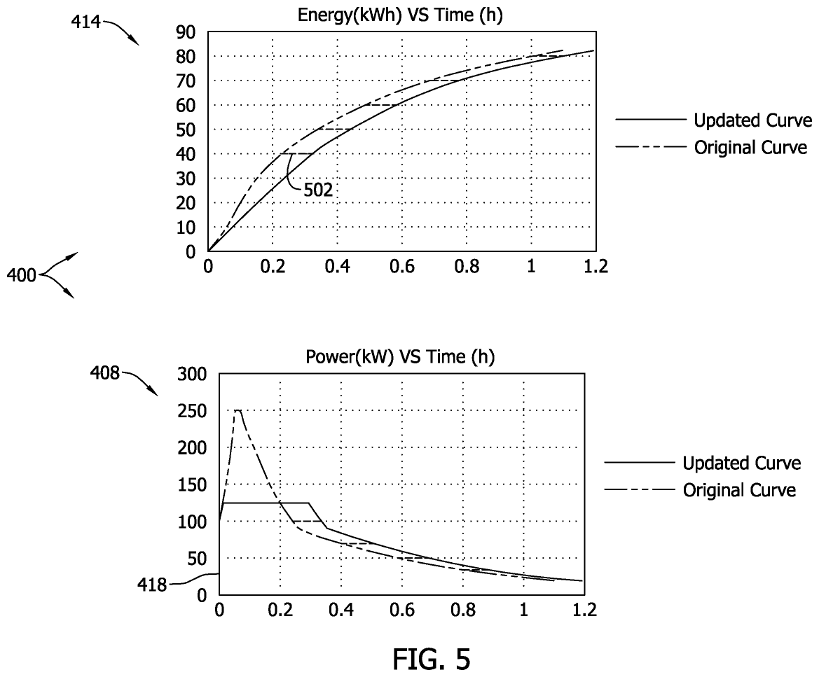

FIG. 5 shows updated charging curves as functions of time with consideration of the maximum charging power of charger 104. Dashed lines 502 show the charging curve is moved in the time axis due to the limitation placed by the maximum charging power of charger 104.

In some embodiments, the arrays representing the charging curves may be further updated by merging consecutive segments having the same charging power into one segment. For example, redundant points may be removed, where consecutive segments having the same charging power values are merged into one single segment, thereby reducing the number of data points in the arrays, reducing requirement on memory and computation load of charging management computing device 102, and increasing the computation speed. Charging curves may be updated to reduce redundant data points beforehand and the final charging curves may be read in during the optimization process. Alternatively, the charging curves may be updated during the optimization process after the initial charging curves are obtained.

In the example embodiment, the charging schedule may be optimized based on the charging curves. The maximum and minimum charged energy of each price period is calculated using the charging curves based on the start and end charged energy and the time period of the price period. The maximum charged energy for a price period corresponds to the charged energy for the price period when the battery is charged at the maximum charging power according to the charging curves. The minimum charged energy for a price period corresponds to the charged energy for the price period when the battery is charged at the minimum charging power to keep the charging session active.

In the example embodiment, the maximum charged energy Et with the maximum charging power during the entire charging session is calculated as:

$${E}_{t} = E f ( t f ( {S}_{i n i} * {E}_{bat} ) + {T}_{c} ) , \qquad ( 13 )$$

where tf( ) is a function of obtaining 1800 the time value on the charging curves corresponding to an input charged energy, Ef( ) is a function of obtaining 1850 the charged energy on the charging curves corresponding to an input time value, Sᵢₙᵢ is the initial SOC of the charging session, E_{bat} is the energy capacity of battery 107, and T_{c} is the total time duration of the charging session.

In the example embodiment, the expected charged energy Ep for reaching the desired final SOC is Eₚ=(S_{final}−Sᵢₙᵢ)*E_{bat}, where S_{final} is the desired final SOC of battery 107. If the maximum charged energy is greater than or equal to the expected charged energy, the desired final SOC may be reached within the charging session. If the maximum charged energy is less than the expected charged energy, the desired SOC cannot be reached within the charging session, and battery 107 will be charged at the maximum charging power throughout the charging session.

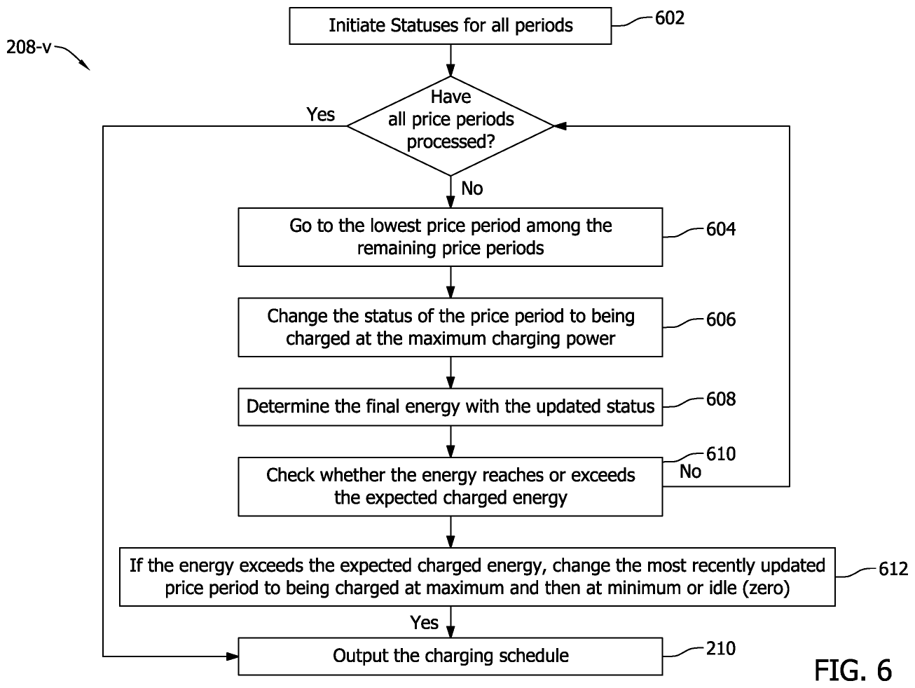

If the example embodiment, if EV 106 can be charged to the desired SOC, an optimized charging schedules for each charging session having i price periods is determined 208 (FIG. 6, also see FIG. 2A). i ranges between N1 and N2. In optimizing 208 a charging schedule for a charging session having i price period, 5 statuses are defined for the price periods, where 0 for being idle, 1 for being charged with the minimum power, 2 for being charging at the maximum power, 3 for being charged with both the minimum and maximum powers for the price period, and 4 for being charged with the maximum power until end and idle after the expected SOC is reached. Statuses 1, 2, and 3 may be assigned to all price periods except for the last price period, while statuses 0, 2, and 4 may be assigned to the last price period. For the last price period, the charging session may end or being idle before the expected charging end time if the expected SOC is reached before the expected charging end time. The last active price period may be set as being charged at maximum charging power until the expected SOC is reached such that the EV owner may choose to leave earlier than the expected charging end time and charger 104 becomes available earlier, increasing the use rate of charger 104.

FIG. 6 is a flow chart of an example method of optimizing 208-v the charging schedule for a charging session having i price periods with consideration of charging curves 400. In the example embodiment, statuses for all price periods are initiated 602. In optimizing 208 a charging schedule with i price periods, the status of price periods 1 to i−1 are set as 1 (being charged with minimum power) and the last price period i as 0 (being idle). The optimization processes 604 the lowest price period among the unprocessed price periods. The charging power of the lowest price period is set 606 to the maximum charging power and the status of the lowest price period is set to 2. The final charged energy with the updated statuses are determined 608 using functions tf( ) 1800 and function Ef( ) 1850. Whether the charged energy reaches or exceeds the desired charging energy is checked 610. If the final charged energy is still lower than the expected charged energy, the optimization moves to next lowest price or goes back to processing 604 the lowest price period among the unprocessed price periods. If the final charged energy is greater than the expected charged energy, the status the most recently updated price period is changed 612 from 2 to 3 or to 4 if the price period is the last price period.

In the example embodiment, to calculate the total charged energy for the updated charging schedule, the total charged energy is calculated in three sections. In the first section, from the first price period to the most recently updated price period, the charged energy of each price period is calculated based on the charged energy of the starting point and the time length of the period using functions Ef( ) and tf( ). The charged energy at the starting point of a given price period is the charged energy at the end point of the immediately prior price period, and may be iteratively obtained based on the starting SOC of the first price period and functions Ef( ) and tf( ). In the second section, from the last price period to the most recently updated price period, the charged energy of each price period is calculated based on the charged energy of the end point of the price period and the time length of the period using functions Ef( ) and tf( ) The charged energy at the end point of a given price period may be obtained as the final desired SOC for the last price period or the charged energy at the starting point of the price period immediately following the given price period, and may be iteratively obtained based on the final desired SOC and functions Ef( ) and tf( ). In the third section, the charged energy for the most recently updated price period may be derived based on the charged energy of the starting point and the charged energy of the end point.

The statuses 0-4 are used as examples for illustration purposes only. Other status indicators may be used. Further, the initial statuses may be set to statuses other than being charging at the minimum charging power or being idle. In changing the status of a price period, the price period having a lower price takes priority in being charged at the maximum charging power over a price period having a higher price. For example, if the initial status is being set as being charged at the maximum charging power, the status of the price period having the highest price is updated first to be charged at the minimum charging power if the price period is not the last price period or being idle if the price period is last price period. If the difference between the charged energy of the price periods with the updated statuses and the expected charged energy is reduced with the update, the updating process continues with the next highest price period among the unprocessed price periods. The goal of the updating process is to minimize the differences between the charged energy with the updated statuses and the expected charged energy.

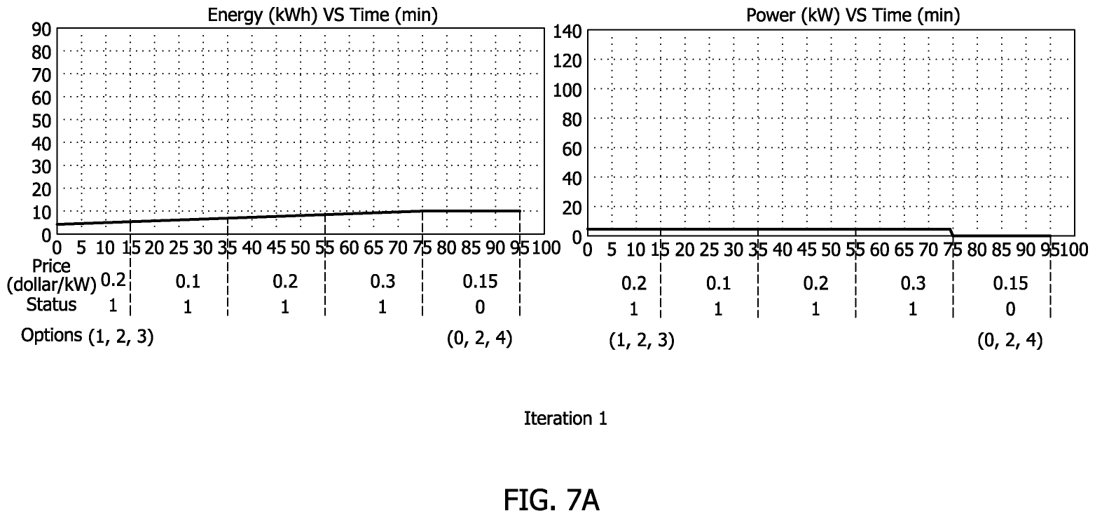

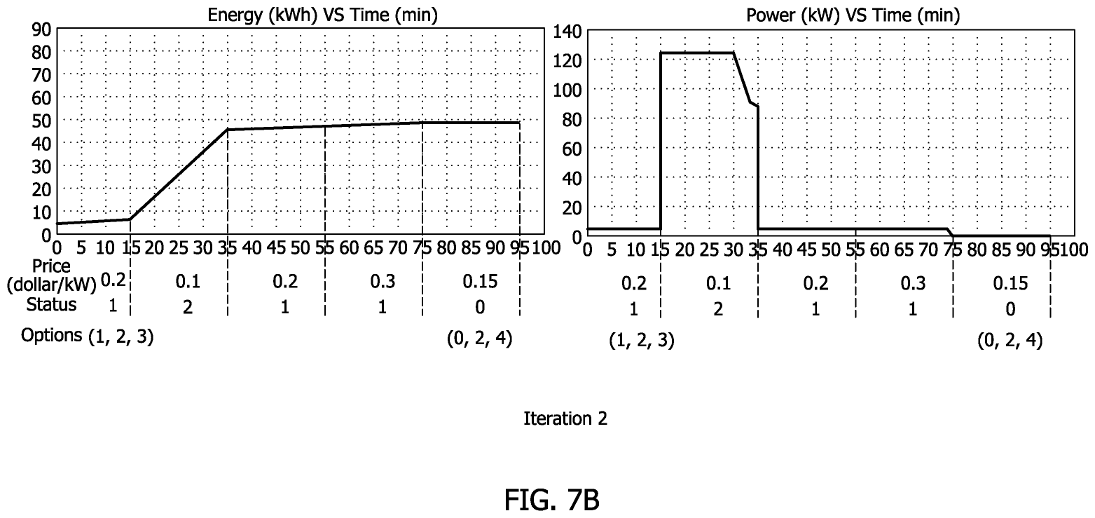

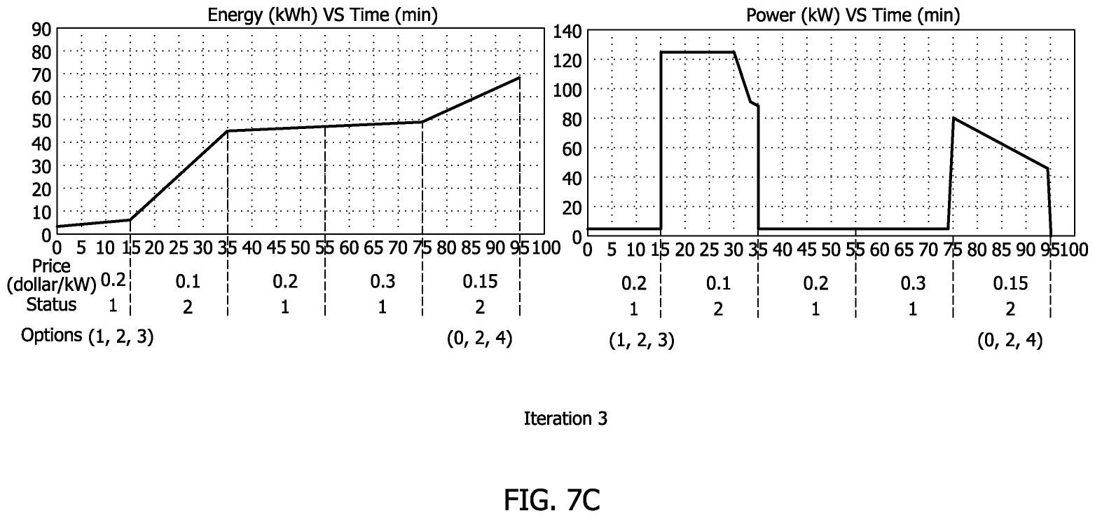

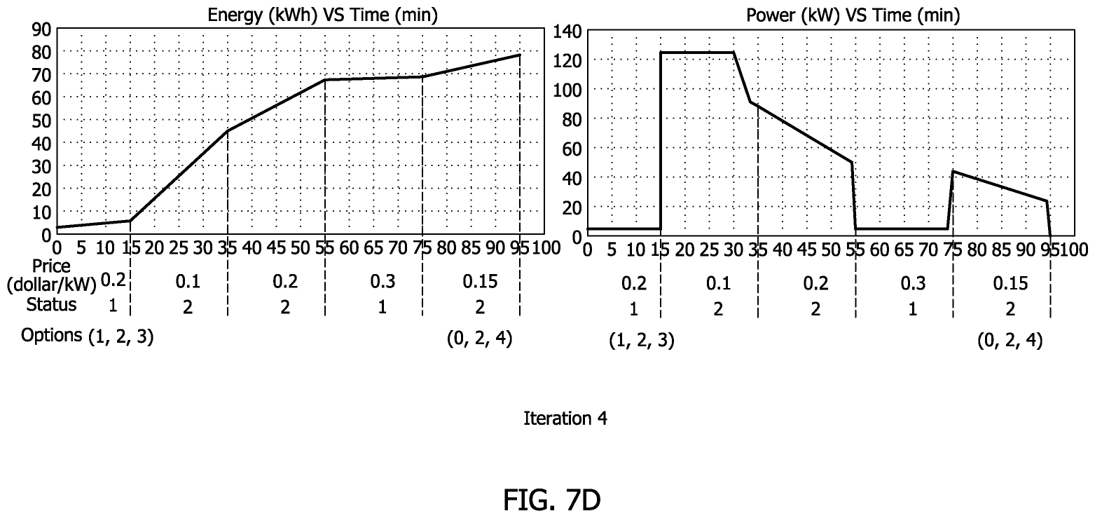

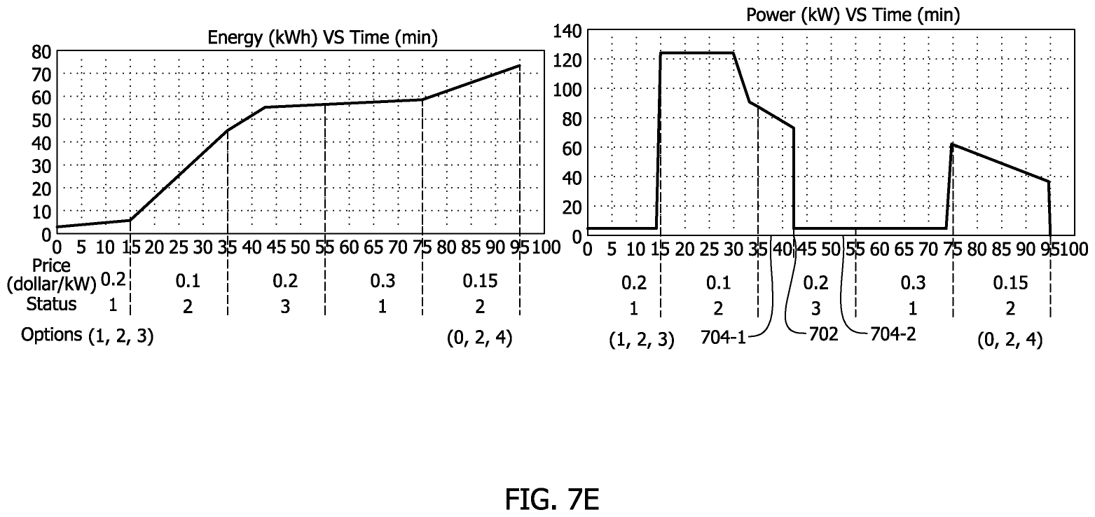

FIGS. 7A-7E show an example embodiment of optimizing 208 a charging schedule with five price periods. In the example embodiment, in iteration 1 (FIG. 7A), the initial statuses of the price periods are set as 1 for price periods 1-4 and as 0 for the last price period 5. The price periods are processed in the order of the prices from lowest to the highest. In iteration 2 (FIG. 7B), the status of price period 2 is set to 2 because price period 2 has the lowest price. In iteration 3 (FIG. 7C), the status of price period 5 is set to 2 because price period 5 has the lowest price among the remaining unprocessed price period. Similarly, in iteration 4 (FIG. 7D), the status of price period 3 is set to 2 because price period 3 has the lowest price among the remaining unprocessed period. At the end of each iteration, the final charged energy is calculated using Ef( ) and tf( ) and compared to the expected charged energy. The process continues until the final charged energy greater than or equal to the expected charged energy.

In the example embodiment, if the final charged energy is equal to the expected charged energy, the optimization ends. In the charging schedule, EV 106 is charged according to the corresponding status for that price period. If the final charged energy exceeds the expected charged energy, the charging of the most recently updated price period is fine-tuned (FIG. 7E) as being first charged at the maximum charging power, and then being charged at the minimum charging power if the price period is not the last period or at zero if the price period is the last price period. In the example, the final charged energy exceeds the expected charged energy after price period 3 is updated. The targeted charged energy of price period 3 is calculated by deducting the charged energy of the starting point of price period 3 from the charged energy at the end point of price period 3. Because price period 3 is not the last price period, the status is changed from 2 to 3. In price period 3, battery 107 is first being charged at the maximum charging power during a first subsegment 704-1 and then being charged at the minimum charging power during a second subsegment 704-2 to keep the charging session active.

In the example embodiment, a transition point 702 from the first subsegment 704-1 to second subsegment 704-2 may be determined by iteratively changing the charging power from the maximum charging power to minimum charging power in intervals preceding the end point until the charged energy for price period 3 is equal to or turns from being greater than to less than the targeted charged energy of price period 3.

In the example embodiment, if the most recently updated price period is the last price period, the status of the most recently updated price period is set to 4, where battery 107 is charged at the maximum charging power during first subsegment 704-1 and is idle during second subsegment 704-1. Transition point 702 may be determined by iteratively changing the charging power from the maximum charging power to zero in intervals preceding the end point of the price period until the charged energy for the price period is equal to or turns from being greater than to less than the target charged energy for the price period.

In the example embodiments, referring back to FIG. 2B, once the optimized schedule is determined 208 for a charging session having i price periods, the optimized schedule for a charging session having a different number of price periods, such as i+1 price periods, is determined. The process is repeated until optimized charging schedules for all numbers of price periods ranging between N1 and N2 have been determined. The cheapest charging schedule among the optimized charging schedules is selected as the final output charging schedule.

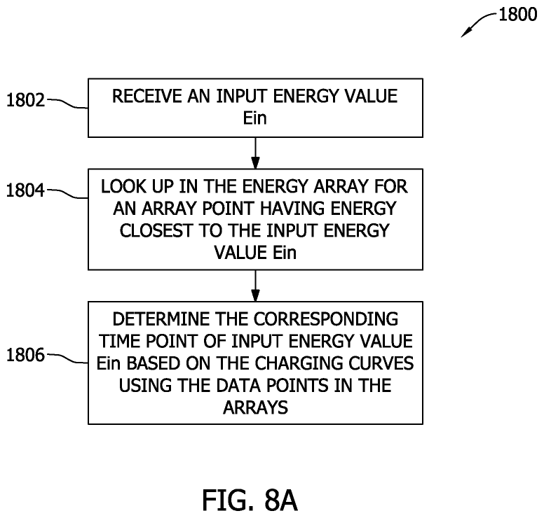

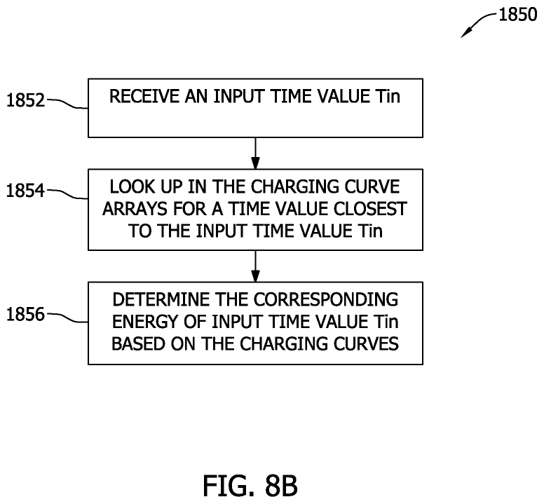

FIG. 8A is a flow chart of determining a time value corresponding to an arbitrary input charged energy Ein based on the charging curves. In the example embodiment, an input charged energy Ein is received 1802. The charging curves are represented as arrays. The data point in the arrays having charged energy closest to the input charged energy is determined 1804 by looking up in the arrays of data points. The time value is determined 1806 based on the identified data points using Eqns. (7) and (8) or Eqns. (11) and (12). For example, because the charged energy curve monotonically increases with time, the index for the charged energy in the arrays may be determined by increasing the index j in the array until the charged energy E[j] is equal to or greater than the input energy Ein. The charged energy in the arrays 412 closest to the input energy may be selected as having the index j−1 in the arrays. The time value may be determined based on the charging curves at index j−1 and Eqns. (7) and (8) or Eqns. (11) and (12). If parameter a is zero, the time value is equal to (Ein−c[j−1])/b[j−1]. If parameter a is not equal to zero, the time value is equal to (In(a[j−1])*Ein+b [j−1])−c[j−1])/a[j−1].

FIG. 8B is a flow chart of determining charged energy corresponding to an arbitrary input time Tin based on the charging curves. In the example embodiment, an input time value Tin is received 1852. The data point in the arrays having the time value closest to the input time value is determined 1854 by looking up in the arrays of data points. The charged energy corresponding to the input value Tin is determined 1856 based on the identified data points using Eqns. (7) and (8) or Eqns. (11) and (12). For example, the index for the time value in the arrays may be determined by increasing the index j in the array until the time value t [j] is equal to or greater than the input energy Tin. The time value in the arrays 412 closest to the input time value may be selected as having the index j−1 in the arrays. The energy value may be determined based on the charging curves at index j−1 and Eqns. (7) and (8) or Eqns. (11) and (12). If parameter a is zero, the charged energy value is equal to b[j−1]*Tin+c[j−1]. If parameter a is not equal to zero, the time value is equal to (exp(a[j−1]*Tin+c[j−1])−b[j−1])/a[j−1].

Systems and methods described herein are advantageous in reducing the computation load and requirements on the computing device in computation power and memory. Calculation in optimization described herein is simplified with the use of the charging model of charged energy and charging power versus time, thereby reducing the computation load and requirements on the computing device. The charging curves may be stored and become readily available, thereby reducing the computation during optimization. For example, in optimizing the charging schedules using charging curves, data points of charging curves may be stored as a look-up table, thereby reducing the computation complexity. Charging curves of various vehicle types may be stored in a database or in a computing device and charging curves corresponding to a specific vehicle type may be retrieved during optimization, thereby reducing the requirements on computation power and storage on charging management computing device 102. Systems and methods described herein apply relatively simple math calculation, unlike in known methods, where complex optimization algorithms are used. As a result, the computation load is further reduced, the requirements on the computing device are reduced, and in-house implementation by chargers or charger managing sites is facilitated to avoid licensing costs for using complex optimization software. The relative simple calculation also facilitates real time update of charging schedules when the charging power does not fully fit the charging curves. Systems and methods may consider the maximum acceptable charging power of the battery, thereby providing accurate optimization of charging schedules. Systems and methods described herein are advantageous in saving costs for EV owners, helping utility operators manage the load in the grid, and improving the user experience by providing relatively fast solution to optimization.

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

Methods described herein may be implemented on charging management computing device 102. Charging management computing device 102 described herein may be any suitable computing device 800 and software implemented therein. FIG. 9 is a block diagram of an example computing device 800. In the example embodiment, computing device 800 includes a user interface 804 that receives at least one input from a user. User interface 804 may include a keyboard 806 that enables the user to input pertinent information. User interface 804 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the example embodiment, computing device 800 includes a presentation interface 817 that presents information, such as input events and/or validation results, to the user. Presentation interface 817 may also include a display adapter 808 that is coupled to at least one display device 810. More specifically, in the example embodiment, display device 810 may be a visual display device, such as a cathode ray tube (CRT), a liquid crystal display (LCD), a light-emitting diode (LED) display, and/or an “electronic ink” display. Alternatively, presentation interface 817 may include an audio output device (e.g., an audio adapter and/or a speaker) and/or a printer.

Computing device 800 also includes a processor 814 and a memory device 818. Processor 814 is coupled to user interface 804, presentation interface 817, and memory device 818 via a system bus 820. In the example embodiment, processor 814 communicates with the user, such as by prompting the user via presentation interface 817 and/or by receiving user inputs via user interface 804. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition and/or meaning of the term “processor.”

In the example embodiment, memory device 818 includes one or more devices that enable information, such as executable instructions and/or other data, to be stored and retrieved. Moreover, memory device 818 includes one or more computer readable media, such as, without limitation, dynamic random access memory (DRAM), static random access memory (SRAM), a solid state disk, and/or a hard disk. In the example embodiment, memory device 818 stores, without limitation, application source code, application object code, configuration data, additional input events, application states, assertion statements, validation results, and/or any other type of data. Computing device 800, in the example embodiment, may also include a communication interface 830 that is coupled to processor 814 via system bus 820. Moreover, communication interface 830 is communicatively coupled to data acquisition devices.

In the example embodiment, processor 814 may be programmed by encoding an operation using one or more executable instructions and providing the executable instructions in memory device 818. In the example embodiment, processor 814 is programmed to select a plurality of measurements that are received from data acquisition devices.

In operation, a computer executes computer-executable instructions embodied in one or more computer-executable components stored on one or more computer-readable media to implement aspects of the invention described and/or illustrated herein. The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

FIG. 10 illustrates an example configuration of a server computer device 1001 such as charging management computing device 102. Server computer device 1001 also includes a processor 1005 for executing instructions. Instructions may be stored in a memory area 1030, for example. Processor 1005 may include one or more processing units (e.g., in a multi-core configuration).

Processor 1005 is operatively coupled to a communication interface 1015 such that server computer device 1001 is capable of communicating with a remote device or another server computer device 1001. For example, communication interface 1015 may receive data from charging management computing device 102 or a charger 104, via the Internet.

Processor 1005 may also be operatively coupled to a storage device 1034. Storage device 1034 is any computer-operated hardware suitable for storing and/or retrieving data. In some embodiments, storage device 1034 is integrated in server computer device 1001. For example, server computer device 1001 may include one or more hard disk drives as storage device 1034. In other embodiments, storage device 1034 is external to server computer device 1001 and may be accessed by a plurality of server computer devices 1001. For example, storage device 1034 may include multiple storage units such as hard disks and/or solid state disks in a redundant array of independent disks (RAID) configuration. storage device 1034 may include a storage area network (SAN) and/or a network attached storage (NAS) system.

In some embodiments, processor 1005 is operatively coupled to storage device 1034 via a storage interface 1020. Storage interface 1020 is any component capable of providing processor 1005 with access to storage device 1034. Storage interface 1020 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1005 with access to storage device 1034.

At least one technical effect of the systems and methods described herein includes (a) optimizing a charging schedule based on charging curves of the battery in an EV; (b) optimizing a charging schedule based on the utility pricing; and (c) generating and updating the charging curves to consider the maximum charging power of the charger and the charging capacity of the battery.

Example embodiments of systems and methods of managing charging of EVs are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A charging management computing device for managing charging of an electric vehicle (EV) at a charger, the charging management computing device comprising at least one processor in communication with at least one memory device, and the at least one processor programmed to:
receive charging information of a charging session of an EV at a charger, wherein the charging information includes a desired state of charge (SOC) and a vehicle type of the EV;
obtain charging curves of a battery of the EV based on the vehicle type;
receive an electricity pricing for the charger;
optimize a charging schedule based on the charging curves and the electricity pricing, wherein the charging schedule includes price periods and corresponding charging power of the price periods, wherein the at least one processor is further programmed to optimize the charging schedule by:
initiating statuses of price periods, wherein the statuses reflect the charging power of the price periods;
processing the price periods in an order of prices of the price periods by:
updating a status of the price period having the lowest price among unprocessed price periods as being charged at the maximum charging power;
determining charged energy based on the charging curves and the updated statuses of the price periods; and
repeating processing the price periods if a difference between the determined charged energy and an expected charged energy corresponding to the desired SOC is reduced; and
updating a status of the most recently updated price period; and
output the optimized charging schedule.

2. The charging management computing device of claim 1, wherein the charging curves include a charged energy curve of charged energy as a function of time and a power curve of charging power as the function of time, and the at least one processor is further programmed to:
obtain the charging curves by:
obtaining a battery capacity of the battery and data points of SOCs and corresponding charging power at a plurality of time points; and
determining parameters of the charging curves by:
setting the charging power as constant during a segment if the charging power is the same at a starting point of the segment as at an end point of the segment; and
setting the charging power as having a linear relationship with time if the charging power is different at the starting point from at the end point.

3. The charging management computing device of claim 1, wherein the at least one processor is further programmed to:
obtain the charging curves by updating the charging curves based on the maximum charging power of the charger.

4. The charging management computing device of claim 1, wherein the at least one processor is further programmed to:
obtain the charging curves by obtaining the charging curves as arrays of parameters representing the charging curves.

5. The charging management computing device of claim 4, wherein the at least one processor is further programmed to:
obtain the charging curves by obtaining the arrays from a database.

6. The charging management computing device of claim 1, wherein the at least one processor is further programmed to:
obtain the charging curves by updating the charging curves by merging consecutive segments having same charging power into one segment.

7. The charging management computing device of claim 1, wherein the at least one process is further programmed to optimize the charging schedule by:
determining the least number of price periods when the battery is charged at a maximum charging power;
determining the greatest number of price periods when the battery is charged at a minimum charging power;
for each number of price periods ranging between the least number and the greatest number,
determining an optimized charging schedule corresponding to the number of prices periods; and
selecting a final optimized charging schedule as an optimized charging schedule with the lowest price among the optimized charging schedules.

8. The charging management computing device of claim 1, wherein the at least one processor is further programmed to:
maintain the charging session active by assigning a nonzero charging power until an end of charging.

9. The charging management computing device of claim 1, wherein determining charged energy further comprises determining the charged energy by:
using a first function of estimating a time value in the charging curves corresponding to an input charged energy to the first function; and
using a second function of estimating a charged energy in the charging curves corresponding to an input time value to the second function.

10. The charging management computing device of claim 9, wherein using a first function further comprises:
receiving the input charged energy;
identifying a charged energy closest to the input charged energy by:
looking up in arrays representing the charging curves; and
determining the time value corresponding to the input charged energy based on data points in the arrays corresponding to the identified charged energy.

11. The charging management computing device of claim 9, wherein using a second function further comprises:
receiving an input time value;
identifying a time value closest to the input time value by:
looking up in arrays representing the charging curves; and
determining the charged energy corresponding to the input time value based on data points in the arrays corresponding to the identified time value.

12. The charging management computing device of claim 1, wherein optimizing a charging schedule further comprises:
determining charging power during the most recently updated price period such that charged energy during the most recently updated price period is equal to a difference between the determined charged energy and the expected charged energy.

13. A method of managing charging of an electric vehicle (EV) at a charger, the method comprising:
receiving charging information of a charging session of an EV at a charger, wherein the charging information includes a desired state of charge (SOC) and a vehicle type of the EV;
obtaining charging curves of a battery of the EV based on the vehicle type;
receiving an electricity pricing for the charger;
optimizing a charging schedule based on the charging curves and the electricity pricing, wherein the charging schedule includes price periods and corresponding charging power during the price periods, wherein optimizing a charging schedule further comprises:
prioritizing charging power for the price periods according to the electricity pricing of the price periods; and
outputting the optimized charging schedule.

14. The method of claim 13, wherein prioritizing charging power further comprises:
dividing the charging session into the price periods based on the electricity pricing, wherein neighboring price periods have different prices;
ranking the price periods in an order of the electricity pricing; and
assigning priority in charging at a maximum charging power to a price period having a first price over a price period having a second price more expensive than the first price.

15. The method of claim 14, wherein assigning priority further comprises:
initiating statuses of price periods, wherein the statuses reflect the charging power of the price periods;
processing the price periods in an order of prices of the price periods by:
updating a status of the price period having the lowest price among unprocessed price periods as being charged at the maximum charging power;
determining charged energy based on the charging curves and the updated statuses of the price periods; and
repeating processing the price periods if a difference between the determined charged energy and an expected charged energy corresponding to the desired SOC is reduced; and
updating a status of the most recently updated price period.

16. The method of claim 15, wherein determining charged energy further comprises determining the charged energy by:
using a first function of estimating a time value in the charging curves corresponding to an input charged energy to the first function; and
using a second function of estimating a charged energy in the charging curves corresponding to an input time value to the second function.

17. The method of claim 13, wherein the charging curves include an charged energy curve of charged energy as a function of time and a power curve of charging power as the function of time, and obtaining charging curves further comprises:
obtaining a battery capacity of the battery and data points of SOCs and corresponding charging power at a plurality of time points; and
determining parameters of the charging curves by:
setting the charging power as constant during a segment if the charging power is the same at a starting point of the segment as at an end point of the segment; and
setting the charging power as having a linear relationship with time if the charging power is different at the starting point from at the end point.

18. The method of claim 13, wherein obtaining the charging curves further comprises updating the charging curves based on the maximum charging power of the charger.

19. A charging management computing device for managing charging of an electric vehicle (EV) at a charger, the charging management computing device comprising at least one processor in communication with at least one memory device, and the at least one processor programmed to:
receive charging information of a charging session of an EV at a charger, wherein the charging information includes a desired state of charge (SOC);
receive an electricity pricing for the charger;
optimize a charging schedule based on the electricity pricing, wherein the charging schedule includes price periods and corresponding charging power during the price periods, wherein the at least one processor is further programmed to optimize a charging schedule by:
dividing the charging session into price periods based on the electricity pricing, wherein neighboring price periods have different prices;
initiating statuses for the price periods as being charged at a maximum charging power; and
processing a price period having the highest price among unprocessed price periods by:
determining charged energy based on the statuses of the price periods;
determining charged energy to be reduced based on the determined charged energy and an expected charged energy corresponding to the desired SOC;
if the price period is not the last price period in the charging session,
comparing the charged energy to be reduced with a difference between a first charged energy of the price period when being charged at the maximum power and a second charged energy of the price period when being charged at the minimum power; and
if the charged energy to be reduced is greater than the difference,
setting a charging power of the price period to be at the minimum charging power; and
going back to determining charged energy based on the statuses; and
if the price period is the last price period,
comparing the charged energy to be reduced with a maximum charged energy of the price period when being charged at the maximum power; and
if the charged energy to be reduced is greater than the maximum charged energy of the price period,
setting a charging power of the price period to zero; and
going back to determining charged energy based on the statuses; and
output the optimized charging schedule.

20. The charging management computing device of claim 19, wherein the at least one process is further programmed to:
optimize the charging schedule by:
determining the least number of price periods when a battery of the EV is charged at a maximum charging power;
determining the greatest number of price periods when the battery is charged at a minimum charging power;
for each number of price periods ranging between the least number and the most number,
determining an optimized charging schedule corresponding to the number of prices periods; and
selecting a final optimized charging schedule as an optimized charging schedule with the lowest price among the optimized charging schedules.
